(19) United States
(12) Patent Application Publication
(10) Pub. No.: US 2017/0151954 A1
(43) Pub. Date: Jun. 1, 2017

(54) CONTROL OF KINETIC ENERGY RECOVERY SYSTEMS

(71) Applicant: Flybrid Automotive Limited, Lancashire (GB)

(72) Inventor: Jonathan HILTON, Oxfordshire (GB)

(21) Appl. No.: 15/321,226

(22) PCT Filed: Jun. 24, 2015
(86) PCT No.: PCT/GB2015/051842

§ 371 Date: Dec. 22, 2016

(30) Foreign Application Priority Data
Jun. 24, 2014 (GB) 1411226.2
Jun. 24, 2014 (GB) 1411227.0

(51) Int. Cl. B60W 30/18; B60W 10/18; B60W 10/06; B60K 6/10; B60W 10/24

(52) U.S. Cl. CPC B60W 30/18127; B60K 6/105; B60W 10/24; B60W 10/06; B60W 10/18; B60Y 2400/162; B60Y 2400/10; B60Y 2300/52; B60W 2510/244

(57) ABSTRACT

The present invention relates to methods of controlling kinetic energy recovery systems (KERS), to controllers, KERS, drivetrains and vehicles including the KERS and controllers. The KERS comprises an energy storage system. In an embodiment, a vehicle is provided with a first vehicle operating mode wherein the energy storage system has a first target state of charge, and with a second vehicle operating mode wherein the energy storage system has a second target state of charge. The first or second vehicle operating mode is selected and energy is transferred between the energy storage system and the vehicle in order to achieve the target state of charge associated with the selected vehicle operating mode. In other embodiments, the KERS includes a variable power transmission device adapted to transfer energy to and from the energy storage system. The energy storage system is maintained at suitable energy levels for the vehicle's driving conditions.

This invention concerns the control and management of power flow and energy storage in Kinetic Energy Recovery Systems (KERS), and in particular those that comprise a high speed flywheel.

### BACKGROUND

Kinetic Energy Recovery Systems (KERS) play an important role in reducing fuel consumption in vehicles by capturing energy due to the motion of the vehicle (i.e. kinetic energy) when the vehicle slows down and reusing it when the vehicle accelerates. This enables the engine to be used less frequently and/or at a lower mean power output, such that the overall fuel consumption and carbon dioxide emissions are reduced. KERS typically take several forms, each with its own characteristics: they may be electric; hydraulic; or mechanical. In certain systems the power and energy capabilities are both dependent upon the storage media characteristics (for example in a battery system) and in others (for example in a mechanical flywheel system) the power capability is separate from the energy storage capability. Furthermore, the capacity of the energy storage media and the power capacity will vary significantly, depending upon the type of system.

Whereas the specific energy storage capability of chemical batteries is relatively high (typically four times that of mechanical flywheels at around 500 kJ/Kg), the rate at which energy may be transferred to or from a battery is limited due to excessive heat that is generated when chemical energy is converted into electrical energy. Thus in order to transfer 120 kW of power (the power of, for example, a small two seater sports car) then chemical batteries with a mass of several hundred kilograms may typically be required. In such an example the batteries may have a theoretical energy capacity of up to 200 MJ, although limitations in tolerable depth of discharge may mean that in practical terms the usable energy storage may be much lower than this.

By contrast, in a mechanical flywheel system the power capacity is largely dependent upon the transmission disposed between the vehicle and the flywheel and the power requirement of the above example (120 kW) may be satisfied by a mechanical transmission with a mass of approximately 40-80 Kg. Thus it may be seen that a mechanical flywheel energy recovery system may be lighter than a battery storage system for a given power transfer requirement. In a mechanical flywheel system, power capacity is entirely separate from the flywheel energy storage capacity which is determined by its speed and inertia, thus the energy capacity may be set appropriately according to the needs of the system, as may the power capacity of the power transmission device. Analysis shows that a relatively low amount of energy (significantly lower than that contained in a battery system which is sized for power capacity) is required to supply a typical small two seater sports car with sufficient kinetic energy to allow it to reach its maximum operating speed; such a flywheel rotor may have a mass in the region of 5-10 Kg, and so is eminently feasible for vehicle fitment even to a lightweight sports car. Similarly it may be shown that in other applications such as city buses where the stop-start nature of the drive cycles makes a flywheel energy storage system suitable, a flywheel of mass 10-15 Kg is sufficient to store the bulk of the vehicle energy at urban speeds.

A mechanical flywheel therefore offers an advantage of low mass compared with other heavier, bulkier and more costly systems such as chemical battery systems.

It should be noted that, while in the present application a flywheel system has been used by way of an example, the problems and solutions proposed are applicable to a wide range of KERS including other electrical systems such as super-capacitor systems, and hydraulic KERS such as pump-motor/accumulator systems.

A challenge exists in that the instantaneous capacity of relatively low energy storage systems such as flywheels may become saturated (that is, full) or depleted at times when a driver may require supplementary engine braking (which may require charging of the energy storage media) or drive power (which may require discharging of the energy storage media). The ability of a driver to access the braking or acceleration effort at will may be termed ‘driveability’.

An aim is to manage the energy storage and power flow in a KERS so that the benefits of fuel efficiency may be achieved without compromise to other KERS benefits such as driveability.

A further challenge exists in that the instantaneous capacity of relatively low energy storage systems such as flywheels may become depleted following periods of intensive demand for vehicle energy, for example following long periods of uphill ascent. Furthermore, it is not always desirable to always run the storage system at a full state of charge. For example, the flywheel of an energy storage system fitted to a vehicle may, at low vehicle speed, be configured to run close to or at its maximum speed (that is, maximum state of charge) so that there is sufficient energy available in the flywheel to propel the vehicle to a higher target speed. Though this is advantageous for vehicle performance, the relatively high parasitic losses associated with such high speed flywheel rotation will potentially compromise the fuel savings and emissions reduction benefits of the KERS (these stemming from harvest and reuse of vehicle kinetic energy). A further, general aim is to manage the state of charge of a KERS such that performance enhancement may be achieved without significant compromise to fuel efficiency improvement.

### SUMMARY OF INVENTION

In a first aspect this invention provides a method of controlling a Kinetic Energy Recovery System (KERS) in a vehicle having an energy storage system comprising providing a first vehicle operating mode (VOM1) wherein the energy storage system has a first target state of charge (TSOC1) and a second vehicle operating mode (VOM2) wherein the energy storage system has a second target state of charge (TSOC2), selecting the vehicle operating mode and transferring energy to or from the energy storage system to achieve the selected target state of charge associated with the selected vehicle operating mode wherein the second target state of charge is higher than the first target state of charge.

The first vehicle operating mode (VOM1) may typically be an economy mode, wherein the state of charge is configured for optimum fuel economy and/or consistency of acceleration and/or braking. The first target state of charge (TSOC1) may be a range of a state of charge (for example, a range of flywheel speeds). The first target state of charge (TSOC1) (for example a flywheel speed) may be set according to the economy mode as described in the fourth, fifth, sixth, seventh and eighth aspects of this invention.

Selection of the target state of charge may be made by the driver of the vehicle or selection may occur based on a control system selected vehicle operating mode or by “deselecting” another vehicle operating mode. For example VOM1 may be the normal mode of operation of the vehicle and the driver may, at their choice, select VOM2 and thereafter a return to VOM1 may occur due to active selection by the driver. Alternatively, a return to VOM1 may occur by operation of a control system which returns the vehicle to its normal mode of operation according to a pre-determined control strategy, for example by returning from a performance mode in VOM2 to an economy mode in VOM1 after a pre-determined period.

In a second aspect, the invention provides a Kinetic Energy Recovery System (KERS) in a vehicle and a control system for the KERS which is operative to provide a first target state of charge (TSOC1) of the energy recovery system which is associated with a first vehicle operating mode (VOM1) and a second target state of charge (TSOC2) of the energy recovery system which is associated with a second vehicle operating mode (VOM2), driver operable means to select the vehicle operating mode whereby the control system causes transfer of energy to or from the energy storage system to achieve the target state of charge associated with the driver selected vehicle operating mode wherein the second target state of charge is higher than the first target state of charge.

Suitably, the KERS may be coupled to the vehicle drivetrain through a variable power transmission device.

The target states of charge may be set according to the intended use modes of the vehicle. For example a mode may be configured to emphasise fuel economy, vehicle performance or a balance between fuel economy and performance. Suitably the TSOC1 may be an ‘economy’ state of charge in which the vehicle is configured to operate so as to maximise fuel economy and TSOC2 may be a ‘performance enhancing’ state of charge in which the vehicle is configured to operate so as to maximise performance.

The driver may select between performance enhancing and economy vehicle operating modes. Preferably the driver may select the performance enhancing mode (for example prior to an over-taking manoeuvre). When the state of charge is higher than the target, energy may be consumed by the storage system such that the state of charge may drift towards its target state of charge (for example, a flywheel may coast down due to its own parasitic losses). Preferably the power transmission device may transfer energy to or from the vehicle (and/or powertrain) and the storage system in order that the target state of charge is approached.

In a third aspect, this invention provides a method of controlling a Kinetic Energy Recovery System (KERS) in a vehicle that includes an energy storage system, at least two vehicle operating modes these being ‘economy’ and ‘performance enhancing’ modes, means for allowing the driver to select said performance enhancing mode, transferring energy to or from the energy storage system to achieve a first target state of charge when the vehicle operating mode is set to the economy mode, transferring energy to or from the energy storage system to achieve a second target state of charge when the vehicle operating mode is set to the performance enhancing mode, wherein the second target state of charge is higher than the first target state of charge.

Preferably the driver may select the performance enhancing mode (for example prior to an over-taking manoeuvre), this generating a signal in a control system, the control system setting a revised (increased) target state of charge for the storage system and the power transmission device transferring energy (typically from the engine) to the storage system such that its state of charge is increased in anticipation of the performance enhancing event.

Preferably, the approach to the target (increased) state of charge is signalled to the driver for example audibly or visually, preferably by a change in the colour, brightness or graphic of a driver interface (such as a button with an illuminated ‘boost’ light that brightens as the target state of charge is approached, or a digital or analogue dial gauge that indicates available KERS energy).

The driver may actively de-select performance enhancing mode, thereby selecting a return to economy mode. Alternatively, the control system may exit the performance enhancing mode and return to the economy mode after a pre-determined time so that the storage system is not held high for prolonged periods, thus limiting the energy losses in the storage system (for example, a high speed flywheel) and therefore maximising fuel economy benefits offered by the KERS. Preferably, the switch to economy mode is made by the control system after a pre-determined period of time, and the change to economy mode is signalled to the driver for example audibly or visually, preferably by a change in the colour, brightness or graphic of a driver interface (such as a button with an illuminated ‘boost’ light that fades or a digital or analogue dial gauge indicates a decrease in KERS storage energy as performance enhancing mode is automatically exited and economy mode is restored).

Following a signal to return to economy mode, the control system may set a revised (decreased) target state of charge for the storage system, and the power transmission device may transfer energy (either to the engine or to the wheels, but typically with the power delivery from the engine being decreased so that the overall delivery of power to the wheels is undisturbed) from the storage system such that its state of charge is decreased in accordance with the switch to economy operating mode. Thus power losses in the storage system (for example, a flywheel) are reduced as the state of charge (in this example this corresponds with a flywheel speed) is reduced.

Advantageously, the driver may not be able to forget that the vehicle is in performance enhancing mode, and therefore fuel may not be unnecessarily wasted due to the storage system state of charge being kept artificially high. Furthermore, the driver may be alerted to the change back to economy mode so that he may expect the vehicle to have reduced power or a reduction in the time for which KERS boost power is available, and may thus adopt a driving style to suit.

Advantageously, the driver's enjoyment may be enhanced through the facility to prepare for boost performance at will, overall satisfaction being enhanced further through the achievement of increased fuel economy over a longer period of time. This allows the use of the KERS for enhanced boost or performance in performance vehicles such as sports cars, but also allows performance enhancement benefits in a wider range of vehicles (such as those used for commuting to and from a place of work) in which fuel economy is also important.

Preferably when in performance enhancing mode the storage system approaches its maximum operating state of charge. Preferably when in economy mode the storage system approaches a target state of charge dependent upon the current speed and/or inertial and/or available inertial energy of the vehicle. Such a maximum operating state of charge may be a constant, or may be variable and/or dependent upon one or more parameters.

Consistent KERS braking capacity may be ensured under all normal braking events by maintaining that state of charge of the energy storage system at or near a target level.

Accordingly, in a fourth aspect this invention provides a method of controlling a Kinetic Energy Recovery System (KERS) for a vehicle including an energy storage system with a pre-determined maximum operating energy storage capacity, a variable power transmission device adapted for transferring energy to and from the energy storage system and vehicle, comprising the following steps: (i) determining the instantaneous available inertial energy of the vehicle, (ii) determining the difference between the maximum energy storage capacity and the instantaneous state of charge to give an instantaneous state of charge headroom, (iii) transferring energy to or from the energy storage system using the variable power transmission device such that the instantaneous state of charge headroom is greater than or substantially equal to the instantaneous available inertial energy of the vehicle.

The maximum operating energy storage capacity may be a fixed limit for the storage device, or it may be a fixed or variable limit based on durability or energy loss requirements.

The available vehicle inertial energy may be defined as the current vehicle kinetic energy. The components of aerodynamic drag and/or foundation braking may optionally be neglected. In this case, the target state of charge of the energy storage system may be maintained close to, or at, the headroom:

$${SOC}_{max} - {SOC}_{target} = {Energy}_{kinetic \_ vehicle \_ available}$$

$${SOC}_{target} = {SOC}_{max} - {Energy}_{kinetic \_ vehicle \_ available}$$

$${SOC}_{target} = {SOC}_{max} - \{ \frac{1}{2} {mv}^{2} \}$$

where: ‘m’ is vehicle mass, ‘v’ is current vehicle speed, Energy_{kinetic}_{_}_{vehicle}_{_}_{available} is the kinetic energy of the vehicle, SOC is state of charge of the energy storage system and the subscripts ‘max’ and ‘target’ refer respectively to maximum and target levels of a quantity.

Calculation of the available kinetic (or inertial) energy may take account of power loss and/or efficiency (η) effects of the power transmission device. The available kinetic (or inertial) energy of the vehicle may be considered to include efficiency (η) effects in the power transmission device, in which case the available kinetic energy of the vehicle may be defined as the product of the instantaneous vehicle kinetic (or inertial) energy and the efficiency of the power transmission device, such that:

$${SOC}_{max} - {SOC}_{target} = η \cdot {Energy}_{kinetic \_ vehicle \_ available}$$

$${SOC}_{target} = {SOC}_{max} - η \cdot {Energy}_{kinetic \_ vehicle \_ available}$$

$${SOC}_{target} = {SOC}_{max} - η \cdot \{ \frac{1}{2} {mv}^{2} \}$$

Consideration may also be given to other loads, including but not limited to frictional loads such as rolling resistance and aerodynamic drag, less other energy sinks such as the anticipated energy dissipation due to the application of foundation brakes (as the KERS may be assisted by the foundation brakes). In this case, the target state of charge SOC_{target} may be estimated as follows (if the one-way efficiency (η) of the power transmission device is neglected):

$${SOC}_{max} - {SOC}_{target} = {Energy}_{kinetic \_ vehicle \_ avaiable}$$

$${SOC}_{target} = {SOC}_{max} - {Energy}_{kinetic \_ vehicle \_ available}$$

$${SOC}_{target} = {SOC}_{max} - \{ \frac{1}{2} {mv}^{2} - {Energy}_{drag} - {Energy}_{foundation \_ braking} - {Energy}_{engine \_ braking} \}$$

Calculation of the available kinetic (or inertial) energy may take account of power loss and/or efficiency (η) effects of the power transmission device as described previously:

$${SOC}_{max} - {SOC}_{target} = η \cdot {Energy}_{kinetic \_ vehicle \_ available}$$

$${SOC}_{target} = {SOC}_{max} - η \cdot {Energy}_{kinetic \_ vehicle \_ available}$$

$${SOC}_{target} = {SOC}_{max} - η \cdot \{ \frac{1}{2} {mv}^{2} - {Energy}_{drag} - {Energy}_{foundation \_ braking} - {Energy}_{engine \_ braking} \}$$

where: ‘m’ is vehicle mass, ‘v’ is current vehicle speed, Energy_{foundation}_{_}_{braking} is the energy estimated to be dissipated due to foundation brakes, Energyₐₑᵣₒ_{_}_{drag} is the total energy that is estimated to be dissipated due to aerodynamic and rolling resistance drag, Energy_{kinetic}_{_}_{vehicle}_{_}_{available} is the available (that is, recoverable) kinetic energy of the vehicle and Energy_{engine} _{_}_{braking} is the energy estimated to be absorbed by engine braking, SOC is state of charge of the energy storage system and the subscripts ‘max’ and ‘target’ refer respectively to maximum and target levels of a quantity. Those skilled in this technical field will be familiar with calculating such drag (aerodynamic drag typically being a function of vehicle frontal area and proportional to the square of vehicle speed) and rolling resistance (which is typically some small proportion of vehicle weight). Estimating the dissipation due to braking on the non-KERS axle may be estimated from signals such as brake pressure, and these may alternatively be made available via the vehicle Control Area Network (CAN) for use by the KERS control system. It may be convenient to use estimated values for Energy_{drag}, Energy_{foundation}_{_}_{braking} or Energy_{engine}_{_}_{braking} based on typical braking events such as those experienced on common urban drive cycles.

Accordingly, in a fifth aspect this invention provides a method of controlling a Kinetic Energy Recovery System (KERS) for a vehicle including an energy storage system with a pre-determined maximum energy storage capacity, a variable power transmission device adapted for transferring energy to and from the energy storage system, comprising the following steps: (i) determining the instantaneous kinetic energy of the vehicle, (ii) estimating a summation of losses over a typical braking event due to foundation braking, engine braking and drag, from the instantaneous kinetic energy of the vehicle, (iii) determining the instantaneous available inertial energy of the vehicle by subtracting the summation of losses over a typical braking event from the instantaneous (or available) kinetic (or inertial) energy of the vehicle, (iv) determining the difference between a maximum energy storage capacity and the instantaneous state of charge to give an instantaneous state of charge headroom, (v) transferring energy to or from the energy storage system using the variable power transmission device such that the instantaneous state of charge headroom is greater than or substantially equal to the instantaneous available inertial energy of the vehicle.

Calculation of the available kinetic (or inertial) energy may take account of power loss and/or efficiency (η) effects of the of the power transmission device. In either or both of aspects four or five, the available kinetic (or inertial) energy of the vehicle may be defined as the product of the instantaneous vehicle kinetic (or inertial) energy and the efficiency of the power transmission device. The efficiency of the power transmission device may be the one-way efficiency.

This may ensure that the KERS can never become full (or saturated) part-way through a braking event thus ensuring consistency of braking effort regardless of the vehicle speed immediately prior to the braking event.

Preferably, the KERS may be connected to one axle, for example the rear axle, while the foundation brakes may act on the remaining axle (in this example the front axle). A control strategy that enables consistent KERS braking may advantageously enable the foundation brakes to be installed on one axle only thus reducing the cost and complexity of the vehicle. Where the KERS is installed in the main drive transmission, the KERS will apply torque to the driven axle or axles. Such driven axle may be either the front or rear axle, or both.

It may be observed that embodiments of this invention may ensure that there is sufficient headroom in the storage system to maintain full KERS braking from any given vehicle speed to rest, and at any rate of braking. This is the case because the energy available to be exchanged between vehicle and the storage system is not a function of the rate of braking, but is simply a function of the vehicle speed; likewise the capacity of the storage system is simply the difference between the maximum state of charge and its current state of charge and is not dependent upon any other parameter.

Thus the facility to exchange energy to and from a vehicle at any vehicle speed (thus, at any vehicle maximum operating inertial energy) is made possible by ensuring that when the vehicle has a large kinetic energy (and thus the ability to transfer this energy to the storage system) then the storage system may preferably maintain a low state of charge. Conversely, if the vehicle has a low kinetic energy then the storage system may preferably be maintained at a relatively high level of charge.

The vehicle maximum operating inertial energy may be a constant or may be variable and/or dependent upon a range of parameters including one or more of: a general speed limitation intrinsic in the vehicle, or an exterior speed limit of the vehicle (such as a local speed limit—for example a speed limit according to an urban area or a motorway/highway, or a local speed limit near a school or a built-up area), or simply a speed limit that has been set by the driver and/or by a control system of the vehicle.

It should also be noted that setting a target state of charge of the storage system as described in this application is also applicable to acceleration as well as braking manoeuvres. Whereas the braking manoeuvre is bounded by zero vehicle speed on the one hand and a maximum state of charge for the energy storage system on the other, the converse must be considered when accommodating acceleration that is boosted by a KERS. In other words, a minimum state of charge of the storage system may be considered for the KERS and a maximum inertial energy (that is, vehicle speed) must be considered for the vehicle. Such a minimum state of charge may be a constant, or may be variable and/or dependent upon one or more parameters. Embodiments of this invention may thus provide an assurance that KERS energy may also be available for acceleration to a pre-determined vehicle speed, whenever required.

Accordingly, in a sixth aspect this invention provides a method of controlling a Kinetic Energy Recovery System (KERS) for a vehicle with a pre-determined maximum operating inertial energy (or speed) and including an energy storage system with a pre-determined minimum state of charge, a variable power transmission device adapted for transferring energy to and from the energy storage system and vehicle, comprising the following steps: (i) determining the instantaneous inertial energy of the vehicle, (ii) determining the maximum operating vehicle inertial energy, (iii) determining the maximum required vehicle inertial energy this being the difference between the maximum operating vehicle inertial energy and the instantaneous vehicle inertial energy, (iv) determining the instantaneous state of charge of the energy storage system, (v) determining the available storage energy this being the instantaneous state of charge minus the minimum state of charge of the energy storage system, (v) transferring energy to or from the energy storage system using the variable power transmission device such that the available storage energy in the energy storage system is greater than or substantially equal to the maximum required vehicle inertial energy.

Calculation of the available kinetic (or inertial) energy may take account of power loss and/or efficiency (η) effects of the of the power transmission device. In this case energy may be transferred to or from the energy storage system using the variable power transmission device such that the available storage energy in the energy storage system is greater than or substantially equal to the maximum required vehicle inertial energy divided by the power transmission device efficiency. The power transmission device efficiency may be its one-way efficiency.

The pre-determined maximum vehicle speed may be fixed, or it may be variable depending upon vehicle operating mode, for example a speed-limiting mode, safety mode or a fuel-saving economy mode of operation.

The KERS may provide a performance enhancement in which energy from the storage system is used to supplement the available engine power. In this case, the total energy available from the engine for the acceleration of the vehicle to a pre-determined maximum vehicle operating speed may be estimated, for example by multiplying the maximum mean engine power by the estimated time to reach the maximum vehicle operating speed.

Accordingly, in a seventh aspect this invention also provides a method of controlling a Kinetic Energy Recovery System (KERS) for a vehicle with a pre-determined maximum operating speed (and corresponding maximum operating inertial energy) and including an energy storage system with a pre-determined minimum state of charge, a variable power transmission device adapted for transferring energy to and from the energy storage system and vehicle, comprising the following steps: (i) determining the instantaneous inertial energy of the vehicle, (ii) determining the maximum required vehicle inertial energy this being the difference between the maximum operating vehicle inertial energy and the instantaneous vehicle inertial energy, (iii) determining the available engine energy for accelerating the vehicle to a maximum required vehicle inertial energy, (iv) determining the instantaneous state of charge of the energy storage system, (v) determining the available storage energy this being the instantaneous state of charge minus the minimum state of charge, (vi) transferring energy to or from the energy storage system using the variable power transmission device such that the available storage energy is greater than or substantially equal to: the maximum required vehicle energy less the available engine energy.

Efficiency (η) effects in the power transmission device may also be taken into account. In this case energy may be transferred to or from the energy storage system using the variable power transmission device such that the available storage energy in the energy storage system is greater than or substantially equal to the maximum required vehicle energy less the available engine energy, divided by the power transmission device efficiency. The power transmission device efficiency may be its one-way efficiency.

Furthermore, the estimated or anticipated effects of aerodynamic drag, rolling resistance and other drag effects (including rolling resistance and aerodynamic drag) may be included in the method when providing KERS for acceleration when operating in a performance enhancement mode of vehicle operation:

Accordingly in a eighth aspect this invention also provides a method of controlling a Kinetic Energy Recovery System (KERS) for a vehicle with a pre-determined maximum operating speed (and corresponding maximum operating inertial energy) and including an energy storage system with a pre-determined minimum state of charge, a variable power transmission device adapted for transferring energy to and from the energy storage system and vehicle, comprising the following steps: (i) determining the instantaneous inertial energy of the vehicle, (ii) determining the maximum required vehicle inertial energy this being the difference between the maximum operating vehicle inertial energy and the instantaneous vehicle inertial energy, (iii) estimating a maximum required loss energy over a typical acceleration event from instantaneous vehicle speed to maximum vehicle operating speed due to drag effects, (iv) determining the available engine energy for accelerating the vehicle to a maximum required vehicle inertial energy, (v) determining the instantaneous state of charge, (vi) determining the available storage energy this being the instantaneous state of charge minus the minimum state of charge, (vii) transferring energy to or from the energy storage system using the variable power transmission device such that a new state of charge of the energy storage system is greater than or substantially equal to the maximum required vehicle energy plus the maximum required loss energy less the available engine energy.

Efficiency (η) effects in the power transmission device may also be taken into account. In this case energy may be transferred to or from the energy storage system using the variable power transmission device such that the available storage energy in the energy storage system is greater than or substantially equal to the maximum required vehicle energy plus the maximum required loss energy less the available engine energy, divided by the power transmission device efficiency. The power transmission device efficiency may be its one-way efficiency.

It may be noted that, if not operating in a performance enhancing mode, then the available engine energy may be considered to be a low value such that it is negligible or zero, in which case the energy storage system may supply most or all of the required vehicle inertial energy in achieving the pre-determined maximum vehicle operating speed.

In transferring the energy to or from the storage system in order that it is maintained at or close to its target state of charge in anticipation of either a braking or an acceleration event, the energy may be successfully utilised rather than wasted or dissipated. For example, if the state of charge is too high, then energy may be transferred using the power transmission device to the wheels whilst power delivery from the engine may be momentarily reduced, thus maintaining the overall power delivery to the wheels. Thus the storage system approaches its target state of charge level whilst the driver's demand for wheel power may be undisturbed. Conversely, if the state of charge is too low, then power delivery from the engine may be increased momentarily such that the power transmission device may transfer energy to the storage system thus causing it to approach the target state of charge. Again, the driver's demand for wheel power may be undisturbed.

If an external event occurs such that the balance between the storage system and vehicle speed (inertial energy) becomes disturbed (for example, if the KERS were to be used to slow a vehicle or maintain its speed over a long downhill incline) then a further strategy may be employed as follows: as the KERS approaches the target state of charge for the instantaneous vehicle speed, KERS braking may be ramped off in a gradual manner such that no sudden disturbance is experienced by the driver. However, a driver's natural response will be to gradually increase braking effort at the pedal in order to regulate vehicle speed. Since the driver continually adjusts the controls such as the driver pedal (throttle or ‘gas’ pedal, as well as brake pedal) at all times in order to accommodate slight changes in prevailing road conditions, then this subtle change in operating mode may be barely perceptible by the driver.

Accordingly, this invention further provides a method according to the fourth or fifth aspect of the invention, further comprising the step of decreasing the power transfer to the storage system as the target state of charge is approached. Optionally, the level of engine braking (and/or the level of foundation braking) may be increased simultaneously with the decrease in KERS power such that the current level of torque at the vehicle drive is maintained at a constant level, or at a level demanded by the driver. In this way, the storage system may be maintained at a desirable state of charge, and a subsequent braking event may be able to utilise the KERS without the energy storage system becoming saturated (that is, full) before such a braking event is completed.

The KERS may comprise a hydraulic storage system such as a fluid accumulator, in which case the power transmission device may include a fluid pump and/or motor.

The KERS may comprise an electrical capacitor storage system such as a super- or ultra-capacitor, in which case the power transmission device may include an electrical conversion device and an electric motor and/or generator.

The KERS may comprise a chemical battery system such as Ni—H or Li-ion battery storage system, in which case the power transmission device may include an electrical conversion device such as an inverter and an electric motor and/or generator.

Preferably, the KERS comprises a high speed flywheel as the KERS energy storage system, and the power transfer (or transmission) device is either a multi-speed clutched flywheel transmission or a continuously variable transmission such as a toroidal traction drive transmission (for example a full toroidal variator). The state of charge is governed by the speed of the flywheel, the KERS power transmission device may control the rate of change of speed of the flywheel (and hence the torque applied to the flywheel and hence also ultimately to the vehicle) but preferably directly controls the torque applied to the flywheel and the vehicle, for example by applying a load to one or more slipping friction clutches contained within the clutched flywheel transmission. Such a device is described in WO-A-2011080512 and the full content of which is incorporated herein by reference. If a variator is included in the power transmission device then preferably this may be torque controlled, and the torque is controlled by controlling the load applied to torque transfer elements (for example rolling elements in a traction drive) within the variator. The variator is preferably a toroidal traction drive, especially preferably a full toroidal traction drive with hydraulically actuated rollers and a hydraulic clamping arrangement for applying the required end load to the rollers. The hydraulic pressure applied to the roller pistons may also be applied to the axial clamp piston such that a substantially constant ratio of roller load to axial clamp load is achieved, this providing good efficiency and durability of the variator. Such an arrangement is described in WO-A-2013110670 and its content is incorporated herein by reference. Alternative energy storage systems such as super-capacitors, ultra-capacitors and various others, including combinations thereof, including combinations with flywheels or flywheel-based systems, may be also be used.

A purpose of controlling the state of charge of the energy storage system associated with the KERS may be that of having access to sufficient KERS braking effort without using the foundation brakes. This may enable the foundation brakes to be downsized or deleted. Furthermore, energy recovery and thus fuel saving may be enhanced. A purpose of controlling the state of charge of the energy storage system associated with the KERS may also be that of enabling the engine of the vehicle to be downsized, which typically makes the engine more efficient (but also reduces its maximum power output). In embodiments wherein the energy storage system is in the form of a flywheel, the flywheel may restore the overall maximum power output capability to the wheels in addition to providing a facility for energy recovery. Fuel saving due to energy recovery is enhanced by an increase in engine efficiency due to the engine downsizing.

### SPECIFIC DESCRIPTION

The invention will now be described, purely by way of example, in connection with the accompanying drawings in which:

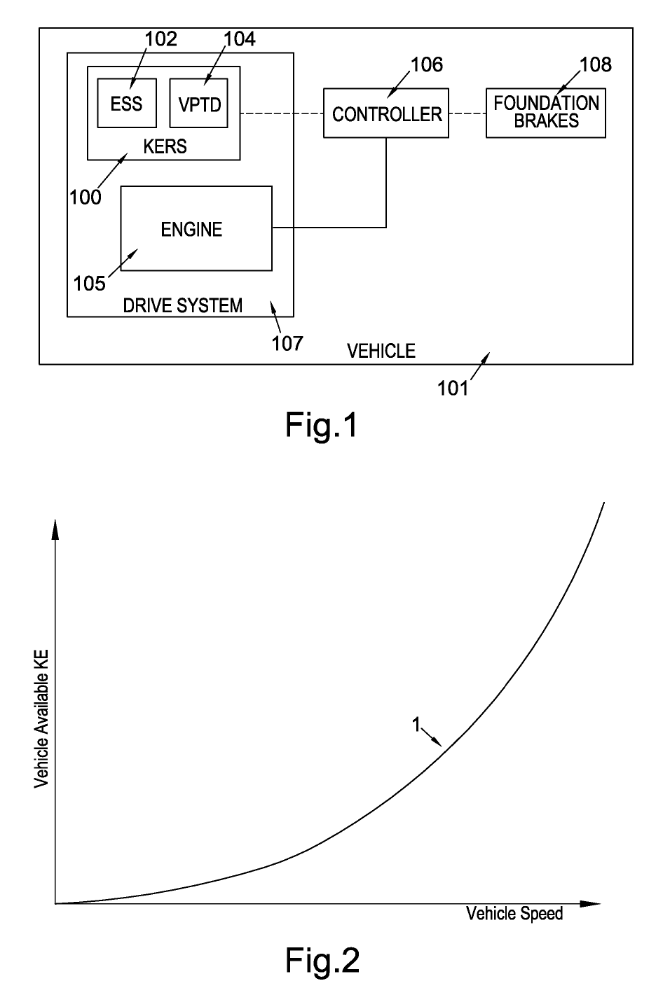

FIG. 1 is a schematic representation of a vehicle according to an embodiment of the present invention;

FIG. 2 is a graph schematically illustrating a vehicle's kinetic energy as a function of speed;

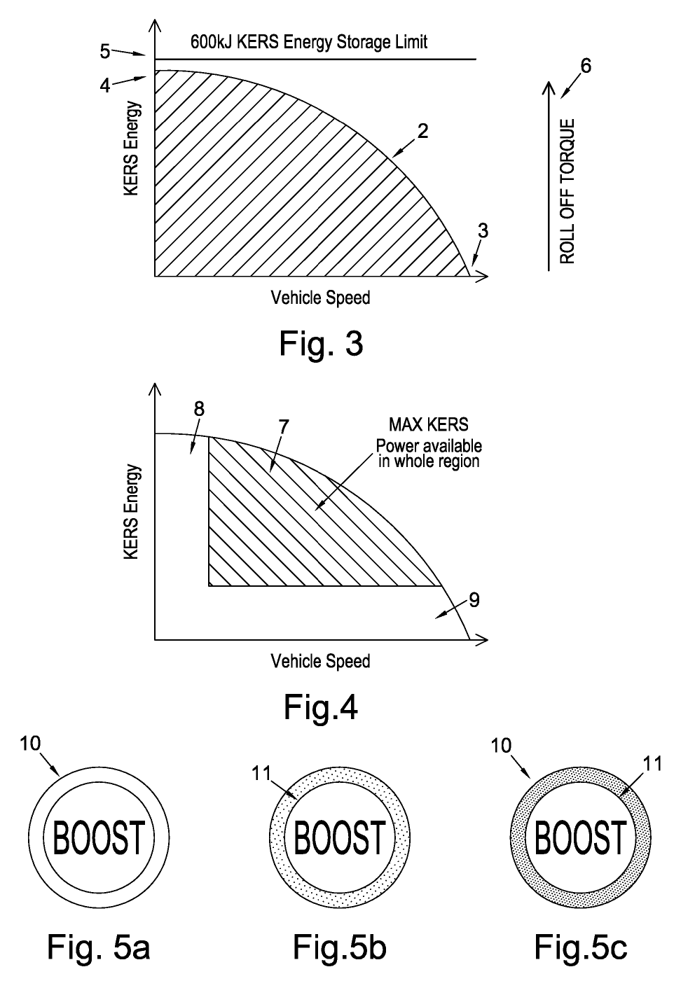

FIG. 3 is a graph schematically illustrating KERS energy as a function of vehicle speed;

FIG. 4 is a graph schematically illustrating maximum KERS power; and

FIGS. 5a, 5b and 5c represent a vehicle boost button for switching vehicle's operating mode and for providing visual information related to the KERS to a vehicle's driver.

FIG. 1 schematically illustrates a vehicle 101 according to an embodiment of the present invention. The vehicle 101 comprises a conventional engine 105 and foundation brakes 108, to control the vehicle's speed and, more generally, behaviour. The vehicle 101 also comprises a kinetic energy recovering system (KERS) 100 comprising an energy storage system (ESS) 102, which, in the described embodiment is in the form of a flywheel (not shown). The KERS also comprises a variable power transmission device (VPTD) 104. The engine 105 and KERS 100 are part of the drive system 107 of the vehicle 101, as shown in the Figure. The drive system may comprise one or more drives or drive components. Drives or drive components may be present, such as for example axels not connected to the drive system 107. Power and energy may thus flow to or from the KERS 100, in particular to or from its associated energy storage system 102, and, for example, exchanged between the energy storage system 102 and the engine 105 of the vehicle and/or between the energy storage system 102 and the vehicle 101. Such power and energy are exchanged via the variable power transmission device 104 of the KERS 100. A controller 106 is provided to govern the behaviour of the KERS 100, engine 105 and foundation brakes 108, as illustrated, particularly by controlling the energy levels of the energy storage system 102.

FIG. 2 shows a graph illustrating a relationship between vehicle speed and vehicle available kinetic (or inertial) energy. The line of increasing gradient reflects the fact that the vehicle kinetic energy is related to the square of vehicle speed, as KE=½mv². Excluding loss, drag and power transfer efficiency effects, the line also describes the preferable state of charge headroom 1 in the energy storage system 102. In the described embodiment of the invention, comprising the KERS 100 having the energy storage system 102 in the form of a flywheel, maintaining this headroom 1 allows the flywheel to absorb the kinetic energy of the vehicle 101 during all braking events such that the energy storage system 102 may not become saturated (full) under normal braking events. Thus braking performance may be consistent under all normal braking events even when predominantly using KERS braking alone.

The curved line on FIG. 3 shows an approximate relationship between vehicle speed and KERS energy target 2 that (excluding efficiency and loss effects) maintains the energy storage system state of charge headroom 1 as a function of vehicle speed. It can therefore be seen that at high vehicle speeds the storage state of charge target 2 approaches a zero or a minimum 3 whereas at low vehicle speeds the storage state of charge target 2 approaches a maximum level 4 which is, in this case, just below a storage limit 5. A further arrow 6 indicates that if the KERS energy storage state of charge 2 approaches the target line under braking (for example after a period of KERS braking on a long downhill slope) then the KERS braking effort may be ‘roll(ed) off’ (that is, decreased gradually, potentially so that KERS braking approaches zero). Further braking of the vehicle 101 may be accomplished by a blend of the foundation brakes 108 and KERS braking such that the overall requested braking level indicated by the driver input such as the brake pedal position is achieved. In addition or alternatively, the driver may monitor the change in braking conditions that arise as the KERS braking effort is rolled off and compensate by applying additional effort at the brake pedal, this being termed ‘driver in the loop’ feedback. If anti-lock braking system (ABS) becomes activated, then a control system may detect the activation of the ABS, for example by receiving a signal over a Control Area Network (CAN) of the vehicle, and may de-activate the KERS braking by ceasing to perform energy transfer to the energy storage system 102 using a power transmission device.

In FIG. 4, a graph shows an area 7 over which consistent required performance (that is, drive rather than braking) may be met using the KERS. The graph describes the KERS being maintained at high state of charge 8 when the vehicle has a low speed (that is, low kinetic energy) and the KERS being maintained at a low state of charge 9 when the vehicle has a high speed (that is, low kinetic energy). An example of a pre-determined maximum vehicle operating speed may be seen where the KERS energy approaches zero energy, and the line cuts the y-axis of the graph.

There are two options of (i) targeting a state of charge of the KERS 100 that ensures consistent performance (as described herein for example for a vehicle economy mode), or alternatively (ii) a selectable ‘boost button’ as shown in FIGS. 5a, 5b and 5c may be depressed for driver selection of a performance mode. A hybrid mode in which engine power and hybrid power may be blended could also be provided. FIGS. 5a, 5b and 5c show a boost button 10 which may be depressed by the driver for the selection of performance mode. In response, the control system causes the flywheel (the storage system in the described embodiment) to be accelerated to an increased state of charge preferably to the maximum state of charge 5. The boost button 10 incorporates an illuminated annulus 11 that indicates when the storage system has approached the target increased state of charge (as shown in FIG. 5c), thus alerting the driver to the state of readiness of the KERS for a high performance manoeuvre such as overtaking. After a pre-determined period of time, the control system causes the flywheel to approach a reduced speed, corresponding to a reduced state of charge, commensurate with the economy mode, and the illuminated annulus 11 in the boost button 10 is caused to fade (as shown in FIG. 5b) such that it is no longer illuminated (as shown in FIG. 5a), and indicating to the driver that the flywheel is no longer charged to the level required for high performance. Thus the driver's enjoyment is enhanced, but fuel economy over a period of time may be achieved.

A telematics system may be provided in which a control system that receives from a database or interprets from an identified road signal information regarding terrain, traffic speed limits and other topographical information, determines from said information a forthcoming supplementary vehicle power requirement, determining a requirement to charge the energy storage system a pre-determined time before the increased vehicle power level is required to be deployed, and discharging the energy storage system when the increase in vehicle power is required.

Conversely, the KERS equipped vehicle may include a control system that receives from a database or interprets from an identified road signal information regarding terrain, traffic speed limits and other topographical information, determines from said information a forthcoming reduction in vehicle power requirement, determining a requirement to dis-charge the energy storage system a pre-determined time before the decreased vehicle power level is required, and charging the energy storage system when the requirement for the decrease in vehicle power is required.

Such systems may be enablers for enhanced reduction of emissions and fuel consumption. For example, if an efficient engine has been incorporated into a vehicle such that the engine displacement is reduced thus enabling higher fuel economy (as is well understood by those skilled in this technical field), then the control system may read information from a speed limit or from an information database that transmits said information regarding an increased forthcoming power requirement (for example, a hill or an increased speed limit that allows the vehicle speed to increase). Thus the control system may cause the energy storage system (for example a flywheel) to receive charge from the engine such that it is pre-charged ahead of the forthcoming requirement for increased power. In this way, the energy storage system may contain sufficient storage in order to supplement the available engine power such that sufficient energy is able to be transmitted to the vehicle in order to satisfy the transient increased power requirement (for example, climbing a hill).

Advantageously this may allow an internal combustion engine or other prime mover to be sized for a lower maximum capacity because the energy storage system may be capable of fulfilling transient increases in power requirement. Prime movers such as internal combustion engines that have a reduced displacement or size exhibit reduced friction characteristics relative to their useful power generation capability (known as indicated power) and therefore tend to exhibit improved efficiency, as well as reduced cost. Therefore, when combined with a control system that receives from a database or interprets from an identified road signal information regarding terrain, traffic speed limits and other topographical information into forthcoming supplementary power requirements, the KERS becomes an enabler not only for increased harvesting and reuse of vehicle kinetic energy, as previously described, but also becomes an enabler for reduced engine size and therefore enhanced reduction of emissions and fuel consumption.

In one embodiment there is a super-economy mode in which the storage system is kept at a low SOC, or is at a zero SOC so that boost to the vehicle from the storage system is not available. Fuel economy may be enhanced because losses in the storage system (such as a flywheel) may be minimised. In such an embodiment, selection of the performance mode by the driver or by a control system may cause the storage system to approach a target state of charge dependent upon the current speed and/or inertial and/or available inertial energy of the vehicle, as described earlier. Thus losses in the storage system (such as a flywheel) may be slightly higher on average than when in the super-economy mode, but boost to the vehicle is always available. This may, for example, always enable the vehicle to achieve a target speed, as described earlier.

Embodiments may also be applicable to commercial vehicles (including on-highway trucks) such as off-highway vehicles, including loaders such as back-hoe loaders and wheeled loaders, and excavators. However in these cases, a modified form of energy recovery system (ERS) may be employed, where the available energy for storage and reuse may be kinetic or gravitational energy or other forms of available energy of the vehicle.

Accordingly, further embodiments may provide a method of controlling an energy recovery system (ERS) for a vehicle (optionally an off-highway vehicle), the ERS comprising an energy storage system having a pre-determined maximum operating energy storage capacity and a variable power transmission device adapted for to transfer energy to and from the energy storage system and vehicle, the method comprising:

(i) determining an instantaneous available energy of the vehicle;

(ii) determining an instantaneous state of charge of the energy storage system;

(iii) determining a difference between the maximum energy storage capacity and the instantaneous state of charge to give an instantaneous state of charge headroom; and,

(iv) transferring energy to or from the energy storage system using the variable power transmission device, such that the instantaneous state of charge headroom is substantially equal to or greater than the instantaneous available energy of the vehicle.

Further embodiments may provide method of controlling an energy recovery system (ERS) for a vehicle (optionally an off-highway vehicle), the ERS comprising an energy storage system having a pre-determined minimum state of charge and a variable power transmission device adapted to transfer energy to and from the energy storage system, the method comprising:

(i) determining an instantaneous energy of the vehicle;

(ii) determining a vehicle maximum operating energy;

(iii) determining a vehicle maximum required energy as a difference between the vehicle maximum operating energy and the vehicle instantaneous energy;

(iv) determining an instantaneous state of charge of the energy storage system;

(v) determining an available storage energy as the instantaneous state of charge of the energy storage system minus the minimum state of charge of the energy storage system;

(vi) transferring energy to or from the energy storage system using the variable power transmission device, such that the available storage energy in the energy storage system is substantially equal to or greater than the vehicle maximum required energy.

Some vehicles may climb to different altitudes regularly the vehicle energy may be gravitational potential energy that may be stored and re-used. In such cases the gravitational energy is a function of the altitude of the vehicle. In loading vehicles, the vehicle energy may be gravitational energy from the loading boom or loading arm. In some vehicles the vehicle energy may be kinetic energy from a part of the vehicle that moves with respect to the vehicle chassis or ground engaging means (such as the cab); such vehicles include excavators. In each case, storage and reuse of the available energy of the vehicle system can reduce fuel consumption. In managing the SOC of the storage system, the engine may be reduced in size which can reduce fuel consumption further, as described earlier. Management of the SOC of the storage system may take account of vehicle aerodynamic losses, vehicle drag, efficiency effects in the power transmission device, engine braking and foundation braking as well as the kinetic or gravitational potential energy as described earlier for the examples that included KERS (i.e. where it is the vehicle's rolling kinetic energy is stored and reused). All other aspects of control that may be applied to the vehicle rolling kinetic energy applications (KERS) may be applied equally to these truck and off-highway applications

The invention has been above described with reference to one or more specific embodiments, purely as an example. The skilled person appreciates that additional and/or alternative embodiments are also encompassed by the invention within the scope defined by the appended claims.

1-10. (canceled)

11. A method of controlling a kinetic energy recovery system (KERS) for a vehicle, the KERS comprising an energy storage system having a pre-determined maximum operating energy storage capacity and a variable power transmission device adapted to transfer energy to and from the energy storage system, the method comprising:
(i) determining an instantaneous available inertial energy of the vehicle;
(ii) determining an instantaneous state of charge of the energy storage system;
(iii) in dependence upon the maximum energy storage capacity and the instantaneous state of charge, determining an instantaneous state of charge headroom; and,
(iv) transferring energy to or from the energy storage system using the variable power transmission device, such that the instantaneous state of charge headroom is substantially equal to or greater than the instantaneous available inertial energy of the vehicle.

12. A method according to claim 11, wherein the maximum operating energy storage capacity is a fixed limit of the energy storage system, or is a fixed or variable limit based on durability or energy loss requirements.

13. A method according to claim 11, wherein the calculation of the instantaneous available inertial energy of the vehicle takes account of one or more of: power losses due to efficiency (η) effects of the variable power transmission device; vehicle drag effects; anticipated energy dissipation due to the application of foundation brakes; and engine braking.

14. (canceled)

15. (canceled)

16. (canceled)

17. A method according to claim 11, wherein the variable power transmission device is adapted to transfer energy to or from the vehicle and the energy storage system.

18. A method according to claim 11, wherein the variable power transmission device is adapted to transfer energy to or from an engine of the vehicle and the energy storage system.

19. A method of controlling a kinetic energy recovery system (KERS) for a vehicle, the KERS comprising an energy storage system having a pre-determined minimum state of charge and a variable power transmission device adapted to transfer energy to and from the energy storage system, the method comprising:
(i) determining an instantaneous inertial energy of the vehicle;
(ii) determining a vehicle maximum operating inertial energy;
(iii) determining a vehicle maximum required inertial energy in dependence upon the vehicle maximum operating inertial energy and the vehicle instantaneous inertial energy;
(iv) determining an instantaneous state of charge of the energy storage system;
(v) determining an available storage energy in dependence upon the instantaneous state of charge of the energy storage system and the minimum state of charge of the energy storage system;
(vi) transferring energy to or from the energy storage system using the variable power transmission device, such that the available storage energy in the energy storage system is substantially equal to or greater than the vehicle maximum required inertial energy.

20. A method according to claim 19, wherein the pre-determined minimum state of charge is a fixed limit for the energy storage system.

21. A method according to claim 19, wherein the pre-determined minimum state of charge is a fixed or variable limit based on durability or energy loss requirements.

22. A method according to claim 19, wherein the determining of the vehicle maximum required inertial energy takes account one or more of: of power losses due to efficiency (η) effects of the variable power transmission device; vehicle drag effects; anticipated energy dissipation due to the application of foundation brakes; and engine braking.

23. (canceled)

24. (canceled)

25. (canceled)

26. A method according to claim 19, wherein the variable power transmission device is adapted to transfer energy one or more of: to or from the vehicle and the energy storage system; and to or from an engine of the vehicle and the energy storage system.

27. A method according to claim 11, wherein braking of the vehicle may be accomplished by a blend of foundation brakes of the vehicle and the KERS.

28. A method according to claim 11, wherein during supply of KERS braking torque to the vehicle the KERS braking torque is reduced, optionally to zero, as the state of charge of the energy storage system approaches a predetermined limit.

29. A method according to claim 28, wherein a driver can compensate for reduction in KERS braking by applying additional effort to a brake pedal.

30. A method according to claim 11, wherein a controller is configured to detect activation of a vehicle anti-lock braking system and to de-activate KERS braking, optionally by ceasing to perform energy transfer to the energy storage system using the variable power transmission device.

31. A method according to claim 11, wherein the energy storage system comprises one or more of: a flywheel; and an electrical capacitor.

32. A controller for controlling a kinetic energy recovery system (KERS) for a vehicle, the KERS comprising an energy storage system and a variable power transmission device for transferring energy to or from the energy storage system, the controller being configured to implement a method according to claim 11.

33. A KERS in combination with a controller according to claim 32.

34. A drive system comprising a KERS adapted to be controlled by a controller according to claim 32.

35. A vehicle comprising a kinetic energy recovery system (KERS) and one or more of:
a controller for controlling a kinetic energy recovery system (KERS) for a vehicle, the KERS comprising an energy storage system and a variable power transmission device for transferring energy to or from the energy storage system, the controller being configured to implement the method according to claim 11;
and a drive system comprising the KERS adapted to be controlled by the controller.

36. A method of controlling a kinetic energy recovery system (KERS) for a vehicle, the KERS comprising an energy storage system having a pre-determined maximum operating energy storage capacity and a pre-determined minimum state of charge, the KERS further comprising a variable power transmission device adapted to transfer energy to and from the energy storage system, the method comprising:
(i) determining a vehicle maximum operating inertial energy;
(ii) determining an instantaneous state of charge of the energy storage system;
(iii) in dependence upon the maximum energy storage capacity and the instantaneous state of charge, determining an instantaneous state of charge headroom;
(iv) determining a vehicle maximum required inertial energy in dependence upon the vehicle maximum operating inertial energy and an instantaneous inertial energy of the vehicle;
(v) determining an available storage energy in dependence upon the instantaneous state of charge of the energy storage system and the minimum state of charge of the energy storage system; and
(vi) transferring energy to or from the energy storage system using the variable power transmission device, such that the instantaneous state of charge headroom is substantially equal to or greater than an instantaneous inertial energy of the vehicle and such that the available storage energy in the energy storage system is substantially equal to or greater than the vehicle maximum required inertial energy.
